(19) United States
(12) Patent Application Publication
(10) Pub. No.: US 2025/0258587 A1
(43) Pub. Date: Aug. 14, 2025

(54) SYSTEMS, METHODS, AND DEVICES FOR OPTIMIZED WEB CONTENT DELIVERY

(71) Applicant: Touchless Holdings, L.P., Middletown, DE (US)

(72) Inventors: Kevin Gervais, Toronto (CA); Stefan Šoć-McLeod, Toronto (CA); Ben Hadley, South Burlington, VT (US); Kyle Mountsier, Hermitage, TN (US); Chris Adams, Barrie (CA); Lin Yang, Thornhill (CA)

(21) Appl. No.: 19/048,093

(22) Filed: Feb. 7, 2025

Related U.S. Application Data
(60) Provisional application No. 63/552,000, filed on Feb. 9, 2024.

(51) Int. Cl. G06F 3/0484; G06F 16/957; G06F 40/14; H04L 67/141

(52) U.S. Cl. CPC G06F 3/0484; G06F 16/9574; G06F 40/14; H04L 67/141

(57) ABSTRACT

Systems, methods, and devices for dynamic web content delivery are provided. The system includes a client device configured to execute a client-side script configured for initiation of one or more simultaneous two-way communication connections, detection and transmission of user actions, and execution of instructions received, for dynamic content updates, from a server for the one or more simultaneous two-way communication connections, the server configured to establish and maintain the one or more simultaneous two-way communication connections with the client device, the server configured for real-time data exchange with the client device to receive user actions, determine an executable response based on a predefined logic, and delivery of the instructions for real-time content manipulation, the instructions including the executable response, and a database configured to manage user-specific data and deliver the user-specific data to the server to support execution of the predefined logic and content customization based on user interactions.

### RELATED APPLICATION DATA

This application is a non-provisional of U.S. Provisional Patent Application No. 63/552,000, filed on Feb. 9, 2024, the entirety of which is hereby incorporated by reference.

### TECHNICAL FIELD

The following relates generally to systems, methods, and devices for web content delivery, and more particularly to systems, methods, and devices for content delivery and personalization.

### INTRODUCTION

In the ever-evolving digital landscape, website loading, and browsing speeds have become critical factors influencing user experience, engagement, and retention. The current internet infrastructure, while robust, often struggles with latency issues, especially when handling dynamic content and interactive features. Users increasingly demand instantaneous responses, and even minimal delays can lead to significant user dissatisfaction and loss of traffic. This pressing need for speed and efficiency in web processing underscores the importance of innovations in web technology.

The traditional model of web communication operates on a request-response paradigm, primarily over HTTP/S protocols, where the client sends a request to the server and awaits a response. This model, while foundational to the web, introduces latency as each request necessitates a round-trip to the server. Additionally, with each request, there is an overhead of HTTP headers and the establishment of a new connection unless kept alive persistently.

Moreover, the HTTP-based delivery of content is unidirectional and it does not facilitate real-time bi-directional communication. This leads to a less dynamic and interactive user experience, as the client cannot receive updates unless it polls the server frequently. This further adds to the latency and increases the load on the server.

Further, most web applications rely on traditional client-server models where the bulk of content processing and rendering occurs on the client side. Technologies like React.js, a popular JavaScript library, facilitate the development of interactive user interfaces. However, these technologies often require the client's device to download substantial amounts of data and execute complex JavaScript code even when only a portion of such code is needed. This can lead to increased loading times, especially on devices with limited processing capabilities or slower internet connections.

Frameworks like React, while powerful for building dynamic user interfaces, contribute to increased front-end code size. This can negatively impact page load times and overall performance, especially on less powerful devices or networks with bandwidth constraints. The reliance on client-side rendering also means that any dynamic content updates necessitate additional client-side processing, further straining resources.

Furthermore, the conventional approach to content delivery and rendering heavily relies on client-side resources. This includes fetching resources like fonts, images, and videos, and rendering them using client-side JavaScript. Such methods can lead to substantial delays in content rendering and reduce the amount of real-time personalization and optimization that can be done, particularly when dealing with media-rich websites or applications with heavy client-side frameworks.

WebSocket technology was introduced to address these limitations by enabling full-duplex communication channels over a single long-lived connection. While web sockets provide a method for real-time, two-way communication between clients and servers, their traditional use has been limited. Typically, web sockets are employed for data exchange wherein the client interprets and processes the data to update the user interface. This process, although efficient for certain applications such as a chat application, does not fully leverage the potential of web sockets in reducing client-side processing and latency.

Security is another critical concern in content delivery. Traditional web communication is susceptible to various attacks, and while HTTPS adds a layer of security, WebSocket connections, due to their persistent nature, require additional security considerations to protect against threats like eavesdropping and man-in-the-middle attacks.

Serving the same static content to all users also overlooks the growing demand for personalization. As web applications have evolved, so have user expectations for content that adapts to their preferences, behaviors, and context in real time. However, implementing personalization while maintaining performance and security, especially across diverse devices and networks, poses significant technical challenges. Therefore, there is a growing need for speed and security in content delivery, coupled with the increasing demand for personalized user experiences.

Current web technologies predominantly rely on continuous fetch requests for data retrieval and updates. This traditional approach, while functional, presents several limitations in terms of efficiency and responsiveness. Fetch requests are typically slower, resource-intensive, and more memory-demanding, leading to reduced performance and increased load times for web applications.

In dynamic environments, such as e-commerce, where prices and inventory change rapidly, existing methods struggle to display real-time availability effectively. This delay in reflecting real-time data can lead to discrepancies in user experience and potential loss of sales or user engagement.

Consequently, there is a noticeable gap in achieving a performant personalized experience. The existing paradigms do not effectively balance performance with dynamic personalization, typically compromising one aspect for the other.

Moreover, personalization, a critical component in enhancing user experience, is impeded by the current methods. Traditional approaches require client-side scripts to fetch personalization data upon page load, which often blocks rendering, leading to issues like flickering. Such methods also pose security risks, as they increase the client-side code's exposure to potential vulnerabilities.

Addressing these challenges requires a novel approach that may reduce latency, minimize client-side processing, and effectively leverage modern technologies like edge computing and advanced WebSocket utilization.

Accordingly, systems, methods, and devices are desired that overcome one or more disadvantages associated with existing web technologies, particularly towards providing content delivery and personalization with improved access speeds and minimized client-side processing.

### SUMMARY

A system for dynamic web content delivery is disclosed. The system includes a client device configured to execute a client-side script, the client-side script configured for initiation of one or more simultaneous two-way communication connections, detection and transmission of user actions, and execution of instructions received, for dynamic content updates, from a server for the one or more simultaneous two-way communication connections; the server configured to establish and maintain the one or more simultaneous two-way communication connections with the client device, the server configured for real-time data exchange with the client device to receive user actions, determine an executable response based on a predefined logic, and delivery of the instructions for real-time content manipulation, wherein the instructions include the executable response; and a database configured to manage user-specific data and deliver the user-specific data to the server to support execution of the predefined logic and content customization based on user interactions.

The one or more simultaneous two-way communication connections may be one or more WebSocket connections, and the server may be a WebSocket server.

In an embodiment, the WebSocket includes a message handler configured to process incoming and outgoing messages related to user interactions and server responses.

In an embodiment, the WebSocket includes a script decision maker to determine the loading and execution of scripts based on user interaction and context.

In an embodiment, the WebSocket includes any one or more of a dedicated server, a cloud-based server instance, and an edge computing worker instance, configured to interpret the user actions sent from the client device and send the instructions for real-time content manipulation.

In an embodiment, the WebSocket server is configured to maintain the one or more WebSocket connections with multiple client devices simultaneously and determine responses based on a combination of user actions, context, and predefined logic and algorithms.

In an embodiment, the WebSocket server is configured to perform real-time interpretation of the user actions received from the client device, the real-time interpretation includes categorizing actions into types such as navigation, interaction, or viewing actions, and dynamically generating responses tailored to a specific context the user action.

In an embodiment, the WebSocket server is configured to send commands to the client device for any one or more of pausing, resuming, or altering an execution flow of the plurality of client-side scripts.

In an embodiment, the client-side script includes a lightweight proxy object configured for intelligent chunking, intercepting function calls, and dynamically loading required code modules and dependencies via the one or more WebSocket connections.

In an embodiment, the WebSocket server is configured to manage a prioritized queue for script execution and resource loading, wherein the client-side script is adapted to determine script activation based on a combination of user interactions, application milestones, and predefined conditions.

In an embodiment, the WebSocket server is configured to interpret real-time changes initiated by client-side scripts, categorize user actions into action types, the action types including DOM changes, script insertions, and function utilizations within the web application, and dynamically generate responses tailored to the action types.

A method for real-time web content delivery and interaction is disclosed. The method includes installing a client-side script on the front end of a web application, the client-side script configured for initiating one or more simultaneous two-way communication connections and processing user interactions; establishing the one or more simultaneous two-way communication connections for continuous data exchange between the client-side script and a remote communication handler for continuous data exchange; detecting and monitoring user actions and HTML manipulations in real-time via the client-side script within a user browser environment for dynamic interaction with the web application; interpreting a plurality of detected user actions at the remote communication handler, and determining an executable instruction in response to the user actions; transmitting the executable instruction from the remote communication handler to the client-side script via the one or more simultaneous two-way communication connections; and executing the received instructions on a client-side user interface for real-time content delivery.

The one or more simultaneous two-way communication connections may be one or more WebSocket connections.

In an embodiment, the remote communication handler includes any one of a server or a serverless function.

In an embodiment, the client-side script includes functionality for pausing and resuming execution based on control commands received from the remote communication handler, allowing for dynamic adjustment of script execution of any script loaded into the web application.

In an embodiment, the method further includes categorizing the user actions into navigation actions, interaction actions, and viewing actions, wherein the remote communication handler tailors the instructions based on the category of the detected user action to enhance the relevance and efficiency of the web application's response.

In an embodiment, the real-time content and DOM manipulations include dynamic updates to the web page's structure, content, and style without requiring a page reload, wherein the dynamic updates are executed immediately upon receiving instructions from the remote communication handler.

In an embodiment, the method includes execution of the client-side script within the same user session, enabling a highly responsive and dynamic user interaction model without the need for page reloads or manual refreshes.

In an embodiment, the one or more WebSocket connections include pushing hydration data to the client, and maintaining the state and functionality of the webpage as the user interacts with it, ensuring a seamless and continuous user experience.

In an embodiment, the method includes rendering and executing transmitted executable content within the client environment, where the executable content is selected and transmitted based on identified update conditions within the client environment, including user actions and interaction patterns, and determined by a WebSocket server in terms of timing and sequence.

In an embodiment, the method includes detecting and analyzing the client device's features including device model, operating system, screen resolution, internet service provider, network conditions, and device capabilities, and assessing, by the WebSocket server content compatibility with detected features to tailor content delivery.

A device for dynamic web content delivery via one or more simultaneous two-way communication connections is disclosed. The device includes a message handler configured to process incoming and outgoing messages through the one or more simultaneous two-way communication connections, including interpreting user actions, requests for data, and commands from a server; a script decision maker configured to determine scripts for load and execution based on user interaction, page context, and client-side script, and dynamically evaluate an application's context and user interactions to determine the scripts to activate within the web application; a state manager configured to manage an application state in real-time by tracking the user interaction and the client-side script; a real-time response unit configured to instantly process user actions received from the message handler and generate appropriate responses, including any one or more of dynamically updating page content, altering layouts, or changing styles, to ensure the web application remains responsive to user needs and server logic; and a queue management module configured to prioritize and sequence the execution of scripts and user actions within a prioritized queue.

The one or more simultaneous two-way communication connections may be one or more WebSocket connections.

A method for dynamic web content delivery and personalization via encoding and decoding is provided. The method includes providing a user agent configured to communicate with an edge worker to retrieve a codec and system payloads and to initialize the codec, the system payloads including first phase system payloads. The codec is configured to encode, decode, and execute the system payloads in the user agent. The method further includes providing the edge worker configured to host the codec and the system payloads for retrieval by the user agent and to communicate with the user agent.

The method may further include the user agent sending a first phase request to the edge worker, the edge worker preparing the codec and further encoding the first phase system payloads responsive to the first phase request, the edge worker sending a module including the codec with the encoded first phase system payloads, the user agent initializing, decoding, and executing operations pursuant to the first phase system payloads, the user agent enabling bilateral full duplex encoding and decoding, the edge worker sending the first phase system payloads and instructions via WebSocket, and the user agent decoding and executing the first phase system payloads.

The one or more simultaneous two-way communication connections may be one or more WebSocket connections.

The codec may be delivered using WASM, and the WASM code may operate in a synchronous manner to achieve greater speed in loading websites and increased security, and imported functions may be supplied separately when the WASM code is initialized in the synchronous manner.

The WASM code may be transformed into a text format suitable for the fetch request including the system payloads, and the WASM code may be delivered in the fetch request that includes the system payloads, and the WASM code may be extracted from the fetch request and initialized in the user agent.

The system payloads may be executed immediately upon decoding.

The system payloads may be encrypted and decrypted using AES 128-bit encryption and decryption.

The system payloads may go through the WebSocket and operate in the user agent to speed up and optimize the user experience.

Other aspects and features will become apparent to those ordinarily skilled in the art, upon review of the following description of some exemplary embodiments.

### BRIEF DESCRIPTION OF THE DRAWINGS

The drawings included herewith are for illustrating various examples of systems, methods, and devices of the present specification. In the drawings:

FIG. 1 shows a block diagram illustrating a system for dynamic web content delivery, according to an embodiment.

FIG. 2 shows a simplified block diagram of device of a dynamic web content delivery system, according to an embodiment.

FIG. 3 shows a system diagram of a WebSocket, according to an embodiment.

FIG. 4 shows a flow chart of method for dynamic web content delivery, according to an embodiment.

FIG. 5 shows a flow chart of method for dynamic web content delivery and personalization, according to an embodiment.

FIG. 6 shows a flow chart of method for dynamic web content delivery and personalization, according to an embodiment.

FIG. 7 shows a flow chart of method for dynamic web content delivery and personalization, according to an embodiment.

FIG. 8 shows a flow chart of method for dynamic web content delivery and personalization, according to an embodiment.

FIG. 9 shows a flow chart of method for dynamic web content delivery and personalization, according to an embodiment.

FIG. 10 shows a flow chart of method for dynamic web content delivery and personalization, according to an embodiment.

FIG. 11 shows a flow chart of method for dynamic web content delivery and personalization, according to an embodiment.

FIG. 12 shows a flow chart of method for dynamic web content delivery and personalization, according to an embodiment.

FIG. 13 shows a flow chart of method for dynamic web content delivery and personalization, according to an embodiment.

FIG. 14 shows a workflow for dynamic web content delivery and personalization, according to an embodiment.

### DETAILED DESCRIPTION

Various apparatuses or processes will be described below to provide an example of each claimed embodiment. No embodiment described below limits any claimed embodiment and any claimed embodiment may cover processes or apparatuses that differ from those described below. The claimed embodiments are not limited to apparatuses or processes having all of the features of any one apparatus or process described below or to features common to multiple or all of the apparatuses described below.

One or more systems described herein may be implemented in computer programs executing on programmable computers, each comprising at least one processor, a data storage system (including volatile and non-volatile memory and/or storage elements), at least one input device, and at least one output device. For example, and without limitation, the programmable computer may be a programmable logic unit, a mainframe computer, a server, and personal computer, cloud based program or system, a laptop, personal data assistance, cellular telephone, smartphone, or tablet device.

Each program is preferably implemented in a high level procedural or object oriented programming and/or scripting language to communicate with a computer system. However, the programs can be implemented in assembly or machine language, if desired. In any case, the language may be a compiled or interpreted language. Each such computer program is preferably stored on a storage media or a device readable by a general or special purpose programmable computer for configuring and operating the computer when the storage media or device is read by the computer to perform the procedures described herein.

A description of an embodiment with several components in communication with each other does not imply that all such components are required. On the contrary, a variety of optional components are described to illustrate the wide variety of possible embodiments of the present invention.

Further, although process steps, method steps, algorithms or the like may be described (in the disclosure and/or in the claims) in a sequential order, such processes, methods and algorithms may be configured to work in alternate orders. In other words, any sequence or order of steps that may be described does not necessarily indicate a requirement that the steps be performed in that order. The steps of processes described herein may be performed in any order that is practical. Further, some steps may be performed simultaneously.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of more than one device or article.

While the present apparatus and processes have been described with reference to particular embodiments, it should be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

In this regard, the scope of the present apparatus and processes is not limited to the specific embodiments disclosed herein. Other variations, modifications, and alternatives are also within the scope of the present apparatus and processes. The appended claims are intended to cover such variations, modifications, and alternatives as fall within their true spirit and scope.

Additionally, the present disclosure is not limited to the described methods, systems, devices, and apparatuses, but includes variations, modifications, and other uses thereof as come within the scope of the appended claims. The detailed description of the embodiments and the drawings are illustrative and not restrictive.

The following relates generally to systems, methods, and devices for web technologies and content streaming, and more particularly to systems, methods, and devices for web content delivery.

Several existing technologies demonstrate aspects of real-time interaction and data processing. However, these systems have limitations when applied to broader web content delivery and personalization. They primarily focus on specific use-cases and do not fully address the complexities of modern web application requirements, such as rapid personalization, security concerns, and efficient data handling at scale.

Consequently, there is a lack of a comprehensive solution that seamlessly integrates real-time data streaming, efficient resource utilization, and dynamic personalization, while also mitigating security risks associated with heavy client-side code. Addressing these challenges requires a novel approach that may reduce latency, minimize client-side processing, and effectively leverage modern technologies like edge computing and advanced WebSocket utilization.

The following discloses systems, methods and devices for web content delivery. The disclosure addresses issues such as latency, security, and the lack of real-time personalization in traditional web applications. The system enables efficient, real-time data streaming, whereby only a minimal initial payload is delivered to the user's browser. The main JavaScript and additional content are streamed subsequently through a WebSocket connection. As a result, the web page's initial load time is reduced, making just a fraction of the content's full size necessary for the initial render.

The WebSocket (also referred to as “socket”) technology allowed data to be pushed from the server to the client in real-time, significantly reducing latency and improving the interactivity of web applications. However, widespread adoption was restricted by compatibility issues with older browsers and the lack of infrastructure support for maintaining persistent connections at scale.

Traditionally, implementing WebSockets required the use of significant server resources, making it expensive and less scalable, especially for applications with a large number of users. However, recent advancements in technology have enabled the use of WebSockets in a more cost-effective and scalable serverless manner. This is primarily facilitated by storing data at the edge of the network as durable objects, which offers persistent and unlimited storage capabilities. This approach significantly reduces resource consumption and operational costs while maintaining high performance and scalability.

Moreover, moving client-side code to instead be executed server-side or using edge-computing reduces public exposure to source codes. This may also reduce or eliminate client-side API calls that would otherwise be exposed.

Additionally, the adoption of these technologies was limited by browser compatibility issues. Previously, not all browsers supported the necessary technology for this kind of sophisticated web application. For example, older versions like Internet Explorer 11 posed limitations. However, with the majority of web users now on WebKit-based browsers, which support these advanced features, it has become feasible to implement such technologies. These recent developments in both serverless edge computing and browser capabilities have opened new possibilities for more efficient, scalable, and interactive web applications, allowing for real-time data streaming and processing.

In an embodiment, a script is installed on the client side of the web application. The client-side may include operations that occur on the web browser of the end user, as opposed to the server-side operations. The script may be a lightweight script on the client's website. This script provides a bridge between the client-side environment and the server-side mechanisms. The script may be designed as minimally invasive, ensuring that it does not significantly impact the initial page load time. Upon loading, the script performs an immediate check to establish a WebSocket connection with the server. Once installed, this script is responsible for establishing a persistent WebSocket connection with the server, setting the stage for real-time, bidirectional communication and content manipulation.

In an embodiment, a WebSocket connection is established. A WebSocket connection may be established between the client and the server. The establishment of a WebSocket connection is initiated immediately after the client-side script is loaded and executed. The process may begin with a WebSocket handshake which is a protocol upgrade request sent from the client to the server. Unlike traditional HTTP connections, WebSockets provide a full-duplex communication channel that remains open for the duration of the user's session. The persistent connection provides for real-time data exchange and immediate execution of server-sent instructions, thereby eliminating the latency typically associated with repeated HTTP requests.

In an embodiment, the front-end manipulations are intercepted by the script. The user or application actions may be detected or monitored by the installed script. The installed script actively monitors for specific user actions or application triggers, such as clicks, scrolls, or page loads. The user actions are detected and responded to in real-time. This provides for a dynamic and responsive user experience.

In an embodiment, the user action is interpreted, and a response instruction is sent. The interpretation of user actions may be performed by the server or in a serverless architecture connected to the client through the WebSocket. In an embodiment, the user action is interpreted on the server side, particularly at the network edge. The interpretation includes computing the necessary response or set of instructions that may be executed on the client side. The instructions may then be sent back to the client through the established WebSocket connection, providing a swift response to the user's actions.

In an embodiment, the front end provides a user interface execution in response to the instructions. The client-side script receives the instructions from the server through the WebSocket. The instructions are executed to manipulate the webpage dynamically. The execution of instructions may include altering the DOM (Document Object Model), updating styles, or even loading new content. The execution is performed in real-time and is highly responsive to user interactions, significantly enhancing the user experience.

Unlike traditional web applications, where data payloads are processed and rendered by the client, the present disclosure enables the direct execution of server-sent instructions for real-time content and DOM manipulation. The real-time content and DOM (Document Object Model) manipulations may include dynamic alteration of a webpage's structure, content, and style, executed immediately as instructions are received from the server through the WebSocket connection. The disclosure reduces the processing load on the client side, as a major part of the processing is performed on the server side, resulting in faster rendering and reduced latency.

In an embodiment, script pausing and execution control are provided to dynamically halt and resume the execution of the client-side script, as well as to regulate the manner in which it executes instructions. The disclosure provides for pausing, resuming, or altering the execution flow of the script based on real-time conditions or server-side logic. The flexibility provides for optimized performance, adapting to varying network conditions or user preferences.

The disclosure provides for continuous interaction between the client and server. Through the persistent WebSocket connection, the server may continuously send optimization instructions or updates to the client, which are executed in real-time. The continuous interaction enables the system to dynamically adapt to changing content needs or user interactions, maintaining optimal performance and user experience.

Although the preferred embodiment of the disclosure includes WebSocket, any suitable simultaneous two-way communication connection may be used in a different embodiment.

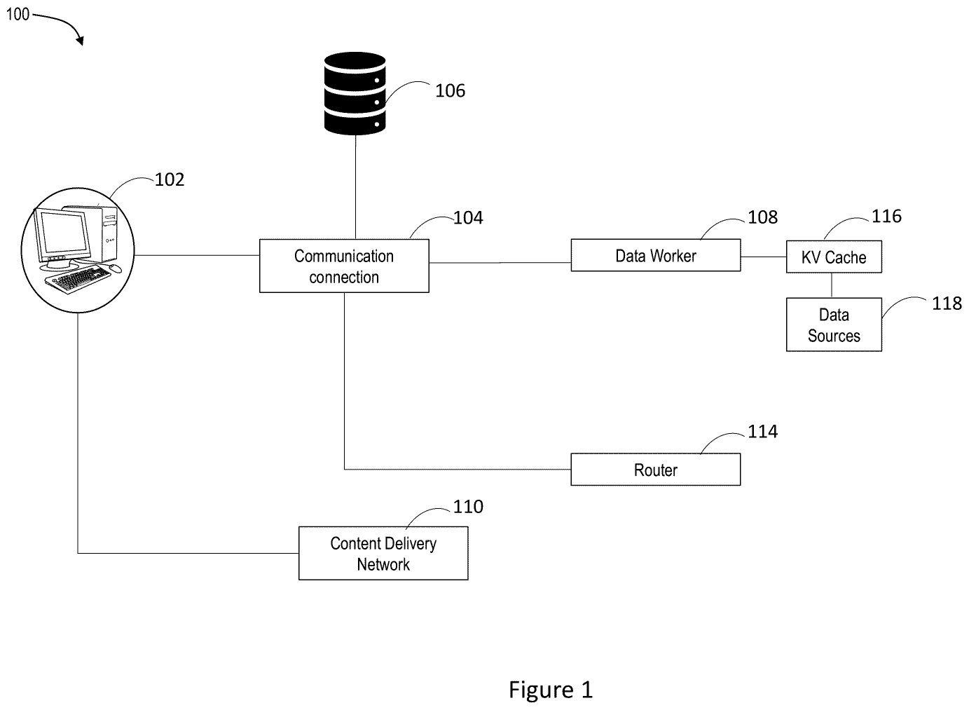

FIG. 1 shows a block diagram illustrating a system 100 for dynamic web content delivery, according to an embodiment.

The system 100 includes client device 102. The client device 102 includes the user's client device, equipped with a standard web browser. The client device 102 may include desktop computers, laptops, smartphones, or tablets. The client device 102 is configured to run the client-side script to interact with the user. Further, the client device 102 may send user actions to the server, and execute instructions received from the server. Additionally, client device 102 includes a lightweight layer dedicated to managing communications with the socket. The client device 102 is the primary interface through which users interact with web applications powered by the system 100.

The script is installed on the front end of the web application. The front end may include a part of the application that runs on the client's device 102, typically within a web browser. The front end includes the user interface elements and client-side scripts that the user interacts with. The script is executed by the browser to facilitate real-time interaction. The script may be written in JavaScript and embedded in the HTML of the webpage.

The client device 102 is configured to load the webpage with the embedded client-side script. The client device 102 establishes and maintains a two-way simultaneous communication connection with the server. The communication connection may be a WebSocket connection. Further, the client device 102 is configured to send user actions to the server and execute received instructions for real-time updates.

The system 100 includes a two-way simultaneous communication connection 104. The communication connection 104 may be the WebSocket 104. The WebSocket 104 may be a WebSocket server, a dedicated server, or a cloud-based server instance. The WebSocket 104 provides for a persistent, full-duplex WebSocket connection with the client device 102. Further, the WebSocket 104 interprets user actions and sends back instructions or data for real-time content manipulation.

The WebSocket 104 establishes a bidirectional communication channel with the client device 102, facilitating continuous data exchange without the need for page refreshes. The WebSocket 104 receives socket messages from client device 102, which encapsulate various user actions, including any one or more of on/scroll, or on/input/update. In return, the WebSocket 104 sends instructions back to the client device 102, comprising a wide range of functionalities, including DOM modification, data-bound content updates, form validations, and execution of JavaScript logic. This bidirectional interaction ensures user interactions are met with swift and dynamic responses, enhancing the overall user experience.

The WebSocket server 104 may accept and maintain WebSocket connections with multiple clients. The WebSocket server 104 is configured to intercept and interpret incoming messages from user device 102. Based on the incoming messages, the WebSocket server determines an appropriate response and sends back instructions or content updates to the client device 102.

The WebSocket server 104 may determine an appropriate response based on a combination of factors including User Actions and Context, and Predefined Logic and Algorithms. For User Actions and Context, the WebSocket server 104 may interpret the nature of the user action received (e.g., a click, scroll, or specific request) and the context in which it occurs (e.g., the user's current position on the site, previously loaded content). For Predefined Logic and Algorithms, the server uses predefined logic and algorithms to decide how to respond. This may include retrieving specific data, triggering certain functions, or generating dynamic content.

The responses pushed by the WebSocket server 104 to the user device 102 may include Dynamic Content: HTML segments, CSS changes, or new media content to be rendered on the client side; Executable Instructions: JavaScript code or functions that the client-side script should execute; or Data Payloads: Information or data structures needed by the client-side script for rendering or processing.

In an embodiment, the system 100 is configured to provide dynamic code loading in web applications for enhancing the efficiency and modularity of web applications. Further, the system is configured to utilize a core framework equipped with a lightweight proxy object. The proxy object provides for intelligent chunking. The proxy object may intercept function calls within the web application and, in response, dynamically load the required code modules and their dependencies through the WebSocket connection to enable on-demand, modular, and isolated execution of application functionalities.

In an embodiment, the WebSocket server 104 is configured to perform as a central hub for managing the WebSocket connections. The WebSocket server 104 is configured to serve the code modules and dependencies requested by the client device 102. The WebSocket server processes the intercepted function calls transmitted by the proxy object, identifies the required code modules, and dynamically sends them back to the client for execution.

In an embodiment, the client-side script includes the implementation of the lightweight proxy object within its framework. The client-side script provides for intercepting function calls, communicating with the WebSocket server 104 to request the necessary code modules, and executing the received modules within the web application's context.

The dynamic loading mechanism enabled by the proxy object provides that only the necessary pieces of code are loaded at any given time. This reduces the initial load time of the web application and enhances overall performance. By loading code modules and their dependencies on-demand, the system 100 promotes modular and isolated execution of application functionalities. This not only improves the responsiveness of the application but also simplifies maintenance and updates, as modules may be independently developed and deployed.

In an embodiment, system 100 is implemented in a serverless architecture. For serverless architecture, services such as AWS Lambda™, Azure™, or Google Cloud™ functions may be used. The serverless architecture provides for responding to specific events triggered by user actions, processes these events, and sends instructions or content updates back to the client terminal.

In the WebSocket server 104 provides for managing script execution and resource loading in real-time.

In an embodiment, the client-side script incorporates logic for determining the activation of scripts within the web application. The client-side script intelligently assesses the context of the application, analyzing user interactions to decide on the script execution. The decision process is designed to activate scripts based not only on user actions but also on specific milestones within the application, time-based triggers, or the fulfillment of certain conditions.

In an embodiment, the system's 100 architecture provides for the management of script execution order through a conceptual prioritized queue, effectively handled by the combined operations of the WebSocket server 104 and the client-side script. As a result, the script execution timing is optimized, by considering script dependencies, impact on application performance, and the user's engagement level. By integrating these functionalities directly into the WebSocket server's 104 processing logic and the client-side script's operational framework, the system 100 provides for efficient resource utilization and enhanced user experience.

Advantageously, the system 100 enhances web applications by intelligently deciding which scripts to activate and precisely timing their execution. Unlike conventional systems where script execution is largely triggered by user actions, the present disclosure provides for incorporating various triggers for script activation. The triggers may include specific system events, predefined conditions, or complex algorithms that assess the current state of the application or user behavior patterns. Once the decision on script activation is made, the system 100 provides for managing resource-intensive assets including fonts or additional scripts, ensuring they are loaded efficiently and at the most opportune moments. Furthermore, the system 100 provides for queue management, strategically determining when each script should run. Therefore, the loading and execution process is optimized, and the application's performance is enhanced.

Furthermore, the system's architecture inherently supports the management of script execution order through a conceptual prioritized queue, effectively handled by the combined operations of the WebSocket server and the client-side script. This mechanism ensures that script execution timing is optimized, considering script dependencies, their impact on application performance, and the user's engagement level. By integrating these functionalities directly into the WebSocket server's processing logic and the client-side script's operational framework, the system guarantees efficient resource utilization and an enhanced user experience. This approach optimizes the loading and execution processes, significantly improving the web application's performance by intelligently scheduling when and how scripts and other resource-intensive assets, such as fonts and additional scripts, are loaded and executed.

In an embodiment, the WebSocket server 104 provides for enhancing the interaction between web applications and users by performing real-time interpretation of changes initiated or observed by multiple client-side scripts. The preferred implementations include modifications within an existing website, actions triggered by scripts, or the utilization of specific functions. The WebSocket server may categorize user actions into distinct action types. The action types may include a range of interactions, such as changes made to the Document Object Model (DOM), the insertion of new scripts into the application environment, use of various functions embedded within the web application. The categorization provides for a nuanced interception and analysis of user actions, facilitating a more responsive and tailored interaction model.

The WebSocket server 104 provides real-time interpretation including the dynamic generation of responses to the specific content of the script action. Based on the nature of the user action, such as a DOM modification, or a new script action, or the use of a particular function, the WebSocket server 104 may intelligently generate and send responses that are most appropriate for the context of the interaction. The dynamic response mechanism provides for a seamless and engaging user experience allowing the web application to adapt in real-time to the user's actions. By providing tailored responses to specific actions, the system 100 aligns the content and functionality of the web application with the user's immediate actions.

The system 100 includes a database server or database 106. The database server 106 may include SQL databases, NoSQL databases, or cloud-based database services. The database server 106 is configured to store user data including content, application logic, and other relevant data. The database server 106 is configured to provide the user data to the WebSocket Server or Serverless functions as needed.

The database server 106 is connected to WebSocket 104 for the communication of data retrieval or updates, typically via HTTP/HTTPS or database-specific protocols.

The database server 106 is configured to store and retrieve data as requested by the WebSocket Server or the Serverless Functions. Further, database server 106 is configured to provide a persistent storage solution for user data, application settings, and content.

The data stored in the database server 106 may include User-Specific Data: User profiles, preferences, and interaction history; Application Data: Dynamic content such as articles, product listings, or interactive elements; and Transactional Data: Information related to user transactions, orders, or interactions that require processing and record-keeping.

The data may be generated through user interactions, backend processing, or third-party integrations and is stored and managed by the database server 106 for efficient retrieval and updating. The WebSocket Server 104 requests this data as needed to respond to client queries or to push updates to the client terminal.

In an embodiment, system 100 includes a dispatcher (not shown) configured as the gateway to the system 100. The Dispatcher provides for routing incoming traffic. During the initial load of a web application, the Dispatcher directs the client device 102 to either the router or the SSR (Server-Side Rendering) router, depending on the specific requirements. Furthermore, the Dispatcher takes charge of setting up the socket connection, ensuring that the client device is seamlessly integrated into the system. The Dispatcher is configured to receive an HTTP request from the user device 102.

In an embodiment, system 100 includes a Content Delivery Network 110. The Content Delivery Network 110 may include services such as Akamai™, Cloudflare™, and AWS CloudFront™. The Content Delivery Network provides for delivering static content like images, CSS, and JavaScript libraries to the client terminal efficiently, reducing load times and server bandwidth.

The Content Delivery Network 110 provides hosts and delivers static resources to the client device 102. The Content Delivery Network 110 is configured to reduce latency by serving content from locations geographically close to the user. The static content delivered by the Content Delivery Network 110 may be referenced or utilized by the dynamic content pushed through the WebSocket server 104.

The website may be hosted on a server, referred to as the back end. The server is responsible for serving the website's content, storing data, and processing server-side scripts. The server may be a physical server in a data center, a virtual server in cloud services like AWST or Azure™, or a serverless architecture depending on the application's requirements. Static resources of the website (like HTML files, CSS, images) may be delivered through a Content Delivery Network (CDN) to optimize performance and reduce server load.

In an embodiment, system 100 includes network infrastructure such as internet service providers, routers, switches, or firewall. The network infrastructure communication between the client terminal 102 and the server components over the internet or other networks. Router 114 may operate as a point of entry for users. The Router 114 may utilize technologies such as the Hono Router. The Router 114 is utilized when users visit a site for the first time or initiate new navigation events. The flexibility of the system allows for the existence of multiple Hono routers, ensuring scalability and adaptability for future needs.

In an embodiment, system 100 includes a Data Worker 108 configured to provide a caching solution. Data Worker 108 operates closely with the KV Cache 116 and Data Sources 118 to optimize data retrieval and storage. Together, Data Worker 108, the KV Cache 116, and the Data Sources 118 form a caching mechanism designed to enhance system performance. Data Worker 108 provides for efficiently managing data, improving response times, and minimizing data access latency.

The KV Cache 116 is a key-value cache, that serves as a storage component within the system 100. The KV Cache 116 stores and retrieves data efficiently, ensuring rapid access and reduced data redundancy. By maintaining a well-organized cache, the KV Cache 116 contributes to the system's overall responsiveness.

Data Sources 118 include a variety of repositories and data stores integrated into the system 100. Data Sources 118 sources are seamlessly integrated into the caching solution, working in conjunction with the Data Worker 108 and KV Cache 116. By providing easy access to data and content, Data Sources 118 provides that the system delivers dynamic and up-to-date information to users.

In an embodiment, a fallback mechanism is provided for scenarios where corporate network settings might block WebSocket connections. This ensures the application remains functional even if the primary WebSocket-based communication is unavailable. This fallback provides for maintaining accessibility and functionality across diverse network environments. The content delivered via fallback methods is tailored to be invisible to search engines, which do not establish WebSocket connections during their indexing process. Therefore, this content remains dynamic and user-specific without being indexed. Where WebSockets may not be available, the system reverts to a traditional method of script loading, where scripts are loaded at the beginning of the page load process. This involves ‘hijacking’ core browser functionalities like window.fetch and window.create element to insert scripts into the page. This ensures that essential scripts are still executed, even if WebSocket communication is not possible.

In an embodiment, the API requests are processed at the edge, ensuring that the system efficiently handles data and requests. The edge computing approach reduces latency and enhances the performance of the application. The client-side sends instructions back to the server, which are then processed and acted upon in real-time, showcasing the system's capability to handle interactive, dynamic web applications effectively.

In an embodiment, the state management is performed at the edge to reduce latency and enhance the responsiveness of the application. The WebSocket facilitates this by sending back user interactions and data, effectively replacing the need for client-side state management. The architecture enables the system to load scripts and content dynamically in response to user actions, rather than delivering a continuous stream of data. This is particularly different from media streaming (like video or audio), where content is delivered in continuous segments.

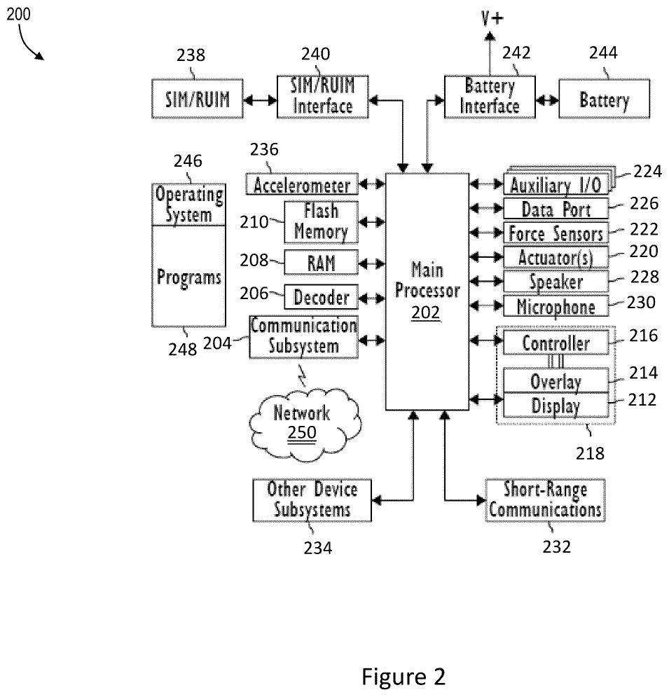

FIG. 2 shows a simplified block diagram of a device 200 of a dynamic web content delivery system, according to an embodiment.

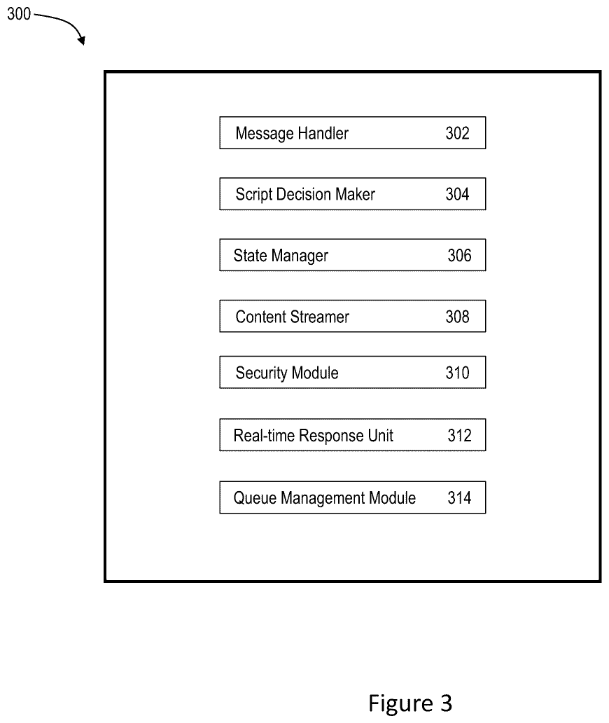

The controller 200 may be the controller 304 of FIG. 3. The controller 200 includes a processor 202 that controls the operations of the controller 200. Communication functions, including data communications, voice communications, or both may be performed through a communication subsystem 204. The communication subsystem 204 may receive messages from, and send messages to, a wireless network 250. Data received by the controller 200 may be decompressed and decrypted by a decoder 206.

The wireless network 250 may be any type of wireless network, including, but not limited to, data-centric wireless networks, voice-centric wireless networks, and dual-mode networks that support both voice and data communications.

The controller 200 may be a battery-powered device and as shown includes a battery interface 242 for connecting one or more rechargeable batteries 244.

The processor 202 also interacts with additional subsystems such as a Random Access memory (RAM) 208, a flash memory 210, a display 212 (e.g. with a touch-sensitive overlay 214 connected to an electronic controller 216 that together comprise a touch-sensitive display 218), an actuator assembly 220, one or more optional force sensors 222, an auxiliary input/output (I/O) subsystem 224, a data port 226, a speaker 228, a microphone 230, short-range communications systems 232 and other device subsystems 234.

In some embodiments, user-interaction with the graphical user interface may be performed through the touch-sensitive overlay 214. The processor 202 may interact with the touch-sensitive overlay 214 via the electronic controller 216. Information, such as text, characters, symbols, images, icons, and other items that may be displayed or rendered on a portable electronic device generated by the processor 202 may be displayed on the touch-sensitive display 218.

The processor 202 may also interact with an accelerometer 236 as shown in FIG. 2. The accelerometer 236 may be utilized for detecting direction of gravitational forces or gravity-induced reaction forces. The processor 202 is configured to interact with the heating elements and icing detector units described herein.

To identify a subscriber for network access according to the present embodiment, the controller 200 may use a subscriber identity module or a removable user identity module (SIM/RUIM) card 238 inserted into a SIM/RUIM interface 240 for communication with a network (such as the wireless network 250). Alternatively, user identification information may be programmed into the flash memory 210 or performed using other techniques.

The controller 200 also includes an operating system 246 and software components 248 that are executed by the processor 202 and which may be stored in a persistent data storage device such as the flash memory 210. Additional applications may be loaded onto the device 200 through the wireless network 250, the auxiliary I/O subsystem 224, the data port 226, the short-range communications subsystem 232, or any other suitable device subsystem 234.

For example, in use, a received signal such as a text message, an e-mail message, web page download, or other data may be processed by the communication subsystem 204 and input to the processor 202. The processor 202 then processes the received signal for output to the display 212 or alternatively to the auxiliary I/O subsystem 224. A subscriber may also compose data items, such as e-mail messages, for example, which may be transmitted over the wireless network 250 through the communication subsystem 204.

For voice communications, the overall operation of the controller 200 may be similar. The speaker 228 may output audible information converted from electrical signals, and the microphone 230 may convert audible information into electrical signals for processing.

FIG. 3 shows a system diagram of a WebSocket 300, according to an embodiment.

In an embodiment, WebSocket 300 includes Message Handler 302. The Message Handler 302 is configured to process incoming and outgoing messages through the WebSocket. This includes interpreting user actions, requests for data, and commands from the server.

In an embodiment, the WebSocket 300 includes Script Decision Maker 304. The Script Decision Maker 304 is configured to determine the scripts or JavaScript should be loaded or executed at any given time, based on user interaction, page context, or other criteria.

In an embodiment, the WebSocket 300 includes State Manager 306. The State Manager 306 is configured to manage the state of the application in real-time. It tracks user interactions, preferences, and the current status of various elements within the user session.

In an embodiment, the WebSocket 300 includes Content Streamer 308. The Content Streamer 308 is configured to handle the streaming of content, such as HTML, CSS, and media, from the server to the client. The Content Streamer 308 provides for the content to be delivered efficiently and in response to user actions or server-side updates.

In an embodiment, the WebSocket 300 includes Security Module 310. The Security Module 310 is configured to provide security by means of encryption, handling session-specific ciphers, or ensuring that data transmissions are secure from eavesdropping or tampering.

In an embodiment, the WebSocket 300 includes Real-time Response Unit 312. The Real-time Response Unit 312 is configured to process and send responses to the client in real-time. This may include dynamically updating page content, altering layouts, or changing styles based on user interactions or server-side logic.

In an embodiment, the WebSocket 300 includes Queue Management Module 314. The Queue Management Module 314 is configured to manage a queue of actions or scripts that are to be executed. The Queue Management Module 314 determines the order and timing of these actions, ensuring that scripts and user requests are handled efficiently and in the correct sequence.

In an embodiment, the Script Decision Maker 304 is configured to decide which scripts are activated within the web application. The Script Decision Maker 304 dynamically evaluates the application's context, user interactions, and other relevant factors to make informed decisions about script execution. The script execution may include activating scripts based on specific milestones reached within the application, time-based triggers, or the completion of specific preconditions.

In an embodiment, the Queue Management Module 314 is configured to manage the execution order of scripts within a prioritized queue. The Queue Management Module 314 determines the optimal timing for each script's execution, taking into account dependencies between scripts, their impact on the application's performance, and the user's current engagement level. By intelligently scheduling script execution, the Queue Management Module 314 provides that resources are used efficiently and user experience is maximized.

Advantageously, the device 300 enhances web applications by intelligently deciding which scripts to activate and precisely timing their execution. Unlike conventional systems where script execution is largely triggered by user actions, the present disclosure provides for incorporating various triggers for script activation. The triggers may include specific system events, predefined conditions, or complex algorithms that assess the current state of the application or user behavior patterns. Once the decision on script activation is made, the device 300 provides for managing resource-intensive assets including fonts or additional scripts, ensuring they are loaded efficiently and at the most opportune moments. Furthermore, the device 300 provides for queue management, strategically determining when each script should run. Advantageously, the loading and execution process is optimized and the application's performance is enhanced.

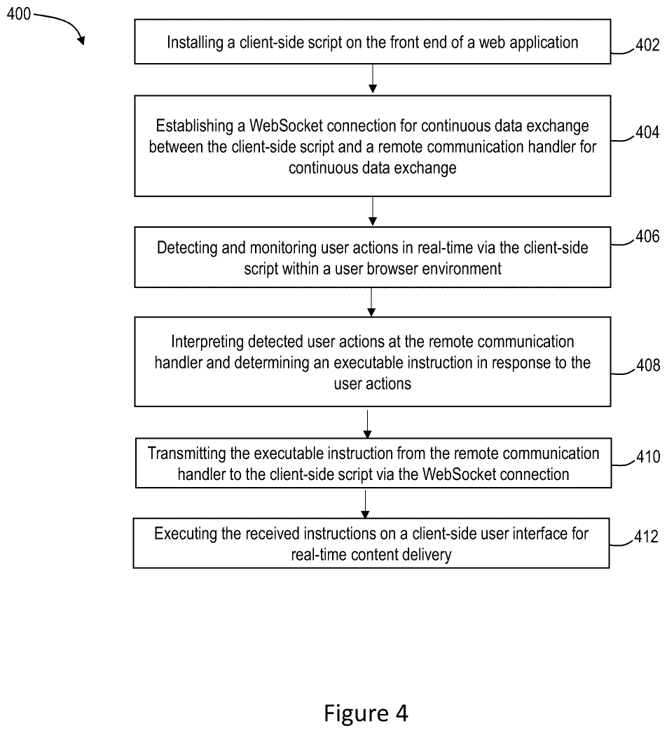

FIG. 4 shows a flow chart of method 400 for dynamic web content delivery, according to an embodiment.

At 402, the method includes installing a script on the front-end or the client side. In an embodiment, a specifically designed script is deployed on the client side of a web application. The client-side script is configured for initiating WebSocket communication and processing user interactions. The term “client side” may refer to operations that occur on the web browser of the end user, as opposed to the server side, where operations occur on the server hosting the web application. The client-side script provides for initiating the real-time, interactive process for web content delivery.

The script may be a compact, lightweight piece of JavaScript code, designed to be non-intrusive and efficient in terms of its loading and execution impact on the webpage. The function script may be to establish and maintain a persistent WebSocket connection with the WebSocket server. The WebSocket connection provides for the bidirectional communication required for the real-time web content manipulation features of the invention.

The script may be configured to be loaded and executed as soon as the webpage begins to load, enabling it to establish the WebSocket connection promptly. The installation of the script onto a website may include adding a short snippet of JavaScript code into the HTML of the web page, preferably within the <head> tag or near the top of the <body> tag to ensure early loading.

Upon loading, the script may perform an immediate check to establish a WebSocket connection with the WebSocket server. The check may include a handshake protocol to ensure a secure and stable connection, for the real-time functionality.

The script may be designed with security and efficiency considerations. The script may employ standard security practices to safeguard the data and interactions between the client and server. Additionally, the script may be optimized for efficiency, ensuring that it consumes minimal resources.

At 404, the method includes establishing a WebSocket connection. The WebSocket connection is established for continuous data exchange between the client-side script and a remote communication handler for continuous data exchange.

A WebSocket is a communication protocol that provides a full-duplex communication channel over a single, long-held TCP connection. It enables interactive communication between a user's browser (the client) and a server. Unlike the traditional HTTP request-response model, where each new request necessitates a new connection, WebSockets maintain an open connection, allowing for continuous data exchange with minimal latency.

The establishment of a WebSocket connection may be initiated immediately after the client-side script is loaded and executed. The establishment of a WebSocket connection may begin with a WebSocket handshake which is a protocol upgrade request sent from the client to the server. The server, upon recognizing the connection request, may respond with an appropriate handshake response, confirming the establishment of a WebSocket connection.

Once the WebSocket connection is established, a persistent, two-way channel of communication is open between the client and server. This enables a type of communication where either party can send messages independently. This provides for real-time interaction capabilities. In an embodiment, the connection may be established between the client-side script and a remote communication handler independent of traditional server or serverless function designations. The remote communication handler may be a server or a serverless function.

The data transmitted over the WebSocket connection may vary based on application requirements. The data may include simple text messages, binary data like images or custom binary formats, instructions for page manipulation, updates to content, or responses to user actions.

On the client side, the script may handle incoming WebSocket messages and execute the instructions contained within. For instance, if the server sends a message to change the webpage's background color, the script interprets this instruction and executes the corresponding JavaScript to alter the DOM.

On the server side, particularly when utilizing edge computing, the server may be programmed to interpret user actions transmitted via the WebSocket and respond with appropriate instructions or content. The server's response time is optimized to minimize latency and enhance the user experience.

Communication over the WebSocket connection is typically triggered by user actions or predefined application manipulations. For example, a user scrolling through a webpage might trigger the server to send additional content dynamically, or a click on a button might prompt the server to send new JavaScript code to be executed by the client.

In an embodiment, the user interaction includes any action initiated by the user on the webpage, such as clicking a button, scrolling, or navigating to a different section. The interactions are dynamic and occur in real-time as the user browses the web application.

For example, in an e-commerce website, when a user scrolls down the product list, the client-side script detects this action and sends a message via WebSocket to the server. The server, in turn, promptly responds with the HTML and data for the next set of products. This data is then dynamically rendered on the client side, leading to a seamless and efficient browsing experience without the need for traditional page reloads or fetch requests.

In an embodiment, the predefined event triggers include specific conditions or events set within the application that automatically prompt a response or action. The predefined event triggers may be time-based (e.g., after a certain duration on a page), context-based (e.g., when a user reaches a particular section of the page), or based on specific user behaviors (e.g., if a user shows interest in a particular product). Both user interactions and predefined event triggers may provide for a responsive and personalized user experience by determining how and when the application responds to the user's actions.

At 406, the method includes detecting and monitoring user actions in real-time via the client-side script within a user browser environment.

The user actions are detected and monitored real-time for dynamic interaction between the client (user's browser) and the server.

User actions may include a range of activities such as clicks, scrolls, typing, or complex gestures like pinch-to-zoom on touch devices. User actions may be categorized based on their nature and the expected response. For instance, user actions may be categorized into navigation actions (e.g., clicks on links), interaction actions (e.g., filling out forms), and viewing actions (e.g., scrolling through content).

The user actions are monitored by the client-side script. The client-side script may monitor by attaching event listeners to various elements of the webpage. For example: clicks may be detected using the “click” event listener; scrolls may be monitored using the “scroll” event; and form submissions may be captured using the “submit” event.

When a user action is detected, the client-side script formats this information into a message that may be understood by the WebSocket server. The message is then sent through the established WebSocket connection to the WebSocket server. The format of the message may be based on a predefined logic so that the WebSocket server may interpret the action and determine the appropriate response. The predefined logic or format of messages sent through the WebSocket connection provides for efficient and accurate communication between the client terminal and the WebSocket server. The predefined format standardization may provide the server to promptly interpret the user actions and determine the appropriate responses. The message format may be defined as part of a structured communication protocol agreed upon by both the client-side script and the WebSocket server. The protocol may outline how messages should be structured, what information they should contain, and how they should be encoded. Alternatively, the messages may be formatted in a universally recognized format like JSON (JavaScript Object Notation). For more complex systems, schema definitions may be used to define the structure of messages.

The predefined logic for interpreting the messages is stored on the WebSocket server. The predefined logic includes parsing the messages, understanding the message structure, and mapping the messages to corresponding server-side actions or responses. The client-side script may include the predefined logic for structuring the messages in the predefined format before sending them to the server.

Upon receiving a message indicating a user action, a server-side component, possibly located at the edge for faster processing, interprets the action. The WebSocket server may include a predefined set of responses or instructions for each type of user action. For instance, a scroll action in an e-commerce site might trigger the server to send back HTML and data for additional products.

The WebSocket server processes the action and sends back a response without any noticeable delay to provide real-time processing. The immediate processing provides an instantaneous and highly responsive user experience.

At 408, the method includes interpreting detected user actions at the remote communication handler and determining an executable instruction in response to the user actions.

At 410, the method includes transmitting the executable instruction from the remote communication handler to the client-side script via the WebSocket connection.

In an embodiment, the interpretation of user actions is primarily performed by the server or serverless architecture connected to the client through the WebSocket connection. When the WebSocket server receives a message indicating a user action (as detected and sent by the client-side script), the WebSocket server interprets the meaning of the user action and determines the response.

The predefined logic for interpreting user actions may be stored and executed on the WebSocket server side. In a server-based architecture, the predefined logic resides on a designated server, potentially at the network edge to reduce latency. In a serverless architecture, the predefined logic may be executed in a stateless compute container managed by a cloud provider, which may be dynamically scaled as needed.

Upon interpreting a user action, the WebSocket server or serverless function determines the appropriate set of instructions to send back to the client. The response determination may be based on predefined rules or algorithms that consider the type of action, the context of the interaction, and the desired outcome. The determination rules may be part of the application's backend logic and may be updated or modified as needed to adapt to new requirements or optimizations. For example, on a social media platform, upon detection of a user action of scrolling through the feed, the determination rule may include, based on the user's past interactions, dynamically curating and sending content to populate the feed, prioritizing posts from frequently interacted topics.

Instructions sent from the WebSocket server may include commands such as “update text”, complex JavaScript functions to be executed, or even HTML or CSS blocks to be rendered. The nature of the instruction may depend on the functionality and design of the web application.

The instructions may be dynamically generated and sent by the server in response to user actions. Upon receiving the instructions, the client-side script executes the instruction, effectively updating the user interface or modifying the webpage in real-time.

For example, in an online store, when a user clicks on a product category, the client-side script communicates the click action to the WebSocket server. The WebSocket server, having the logic and data for product categories, sends back instructions to display products in that category. The instructions may include HTML for the product list and JavaScript to handle user interactions with these products.

Further illustrating a serverless architecture, in a customizable news portal, when a user selects a specific news topic, the user action is sent to a serverless function. The function, based on user preferences and past interactions (stored and accessed dynamically), generates and sends back instructions to rearrange or populate the news feed accordingly.

The method provides for dynamically and intelligently responding to user interactions. Whether through a server or a serverless architecture, the method provides for interpreting user actions, determining the best response in the form of instructions, and sending these back to the client for execution. The method not only enhances user experience through real-time interactivity but also allows for a scalable and efficient web application architecture, adapting to the specific needs of each user interaction.

At 412, the method includes executing the received instructions on a client-side user interface for real-time content delivery.

The front-end user interface execution may include the client-side script, running in the user's browser, executing the instructions received from the server via the WebSocket connection.

The execution may include dynamic content updates, layout changes, or other DOM modifications as directed by the server. The script may parse the instructions and execute them. The parsing and execution of instructions may include invoking JavaScript functions, inserting or updating HTML content, or altering CSS styles. In cases where new content is sent by the server (like images or text), the script may render the new content on the page in real-time.

The DOM (Document Object Model) is a programming interface for web documents. It represents the page structure as a tree of objects, which JavaScript may interact with to change the document's structure, style, and content. Altering the DOM includes updating this structure, which, in turn, updates the webpage the user sees.

In an embodiment, the execution of DOM manipulations and content updates occurs on the client side driven by instructions from the WebSocket server. When the client-side script receives an instruction via WebSocket connection, the client-side script interprets and executes the instruction directly. The instruction may include inserting new HTML elements, changing styles, or dynamically loading additional scripts or media.

Advantageously, the initial load for processing is reduced since the bulk of dynamic content manipulation logic is offloaded to the WebSocket server, and the initial load of the webpage is lighter, leading to faster page load times. Further, the WebSocket connection provides for real-time and immediate execution of server-sent instructions, providing a more responsive and interactive user experience. By minimizing the client-side processing and reducing the amount of JavaScript that needs to be downloaded and executed, the efficiency of content delivery is improved, particularly for users on limited bandwidth or devices with lower processing power.

In an embodiment, the WebSocket provides for pushing through hydration data to the client. The hydration data provides for maintaining the state and functionality of the webpage as the user interacts with it, ensuring a seamless and continuous user experience.

The hydration data may refer to the process and information needed to update a web application's user interface in real time. When a web application initially loads, it often presents a static view of the content. As the user interacts with the application, hydration data is sent to the client, containing dynamic updates or state changes. The hydration data updates the static content, transforming it into an interactive and dynamic interface.

The method provides for establishing a persistent communication stream for web applications. The communication stream, unlike traditional intermittent fetch requests, allows for more efficient and continuous data exchange between the client and the server. In an embodiment, the persistent communication stream is implemented via a WebSocket for real-time data updates and dynamic content personalization.

In an embodiment, the method includes detecting and monitoring HTML manipulations performed on a web application in real-time via the client-side script within a user browser environment accessing the web application.

The client-side script is embedded within the web application and runs directly in the user's browser environment. The script may be designed to continuously scan and identify any modifications made to the HTML structure of the web application. The modifications may include changes initiated by user interactions, such as clicking, scrolling, or entering data, as well as updates that occur automatically through other scripts running within the application. The client-side script may leverage event listeners and DOM observation techniques to monitor the HTML document for any additions, deletions, or alterations in real-time. Upon detecting changes, the script may process this information to understand the nature of the manipulation and subsequently execute predefined logic to respond. The response may include dynamically updating the user interface, fetching additional data from the server without a page reload, or activating further script actions to enhance the interactive experience.

In an embodiment, the method includes performing real-time content and DOM manipulations.

Real-time content and DOM (Document Object Model) manipulations include dynamic alteration of a webpage's structure, content, and style, executed immediately as instructions are received from the WebSocket server through the WebSocket connection. The dynamic alterations or updates are performed without requiring a page reload. In an embodiment, the dynamic updates are executed immediately upon receiving instructions from the remote communication handler.

Upon receiving instructions from the WebSocket server, the client-side script instantly executes the instructions, altering the DOM in real-time. The executions may include adding new HTML elements, modifying existing ones, changing styles, or even dynamically loading scripts and media. The WebSocket server may send specific instructions based on the user's actions and the current state of the webpage. The client-side script provides dynamic rendering wherein it renders new content or updates the existing content instantly as the script receives instructions, without the need for a page reload or additional HTTP requests.

In an embodiment based on server architecture, the WebSocket server that maintains the WebSocket connection interprets user actions and sends back tailored instructions for DOM manipulations to the front-end. The WebSocket server may have access to user session data and other contextual information, which the WebSocket server uses to generate these instructions.

In an embodiment based on a serverless model, stateless functions respond to events (user actions communicated via WebSocket) and send back instructions for DOM updates. The serverless architecture provides for high scalability and cost-effectiveness, as resources are used only when functions are executed.

In contrast to traditional systems where the client-side script decides when and how to fetch and render new content, in the present method, these decisions are made by the server. Advantageously, by not relying on client-initiated requests to fetch new data and update the DOM which introduces latency, the method provides for an open WebSocket connection for continuous, real-time updates. Further, by offloading the decision-making and data processing to the server, the method optimizes resource utilization on the client side.

In an embodiment, the method includes script pausing and execution control. The script pausing and execution control may provide for dynamically halting and resuming the execution of the client-side script, as well as regulating how the instructions are executed. The feature provides for optimizing performance, managing resource allocation, and enhancing user experience.

Pausing the script includes temporarily halting the script operation without completely stopping or unloading it. The pause may be initiated and controlled by the server. The script may be paused in response to various events or conditions. For example, network instability, high server load, user inactivity, or even specific user actions can trigger a pause. The script may be paused to optimize resource usage, reduce unnecessary data transfer, and prevent potential conflicts or errors in executing real-time updates.

Execution control may include the ability to manage how and when the script executes its functions. Specifically, execution control may include starting, stopping, pausing, resuming, or changing the execution flow of the script. The server (or serverless function) may send control commands via the WebSocket connection, instructing the script to alter its execution. The commands may include instructions to delay certain actions, prioritize others, or adjust execution parameters based on current conditions.

In an embodiment, the client-side script receives control commands from the server, which are transmitted over the WebSocket connection. Upon receiving a command, the script interprets it to understand whether to pause, resume, or adjust its execution. The script may then execute the command. For a pause, the script halts its activities while maintaining its state. For other control adjustments, the script modifies its execution accordingly.

Script pausing and execution control provides a mechanism to optimize performance and resource utilization. By allowing the server or serverless functions to dynamically control the client-side script's operation, the method improves efficiency and responsiveness to web applications.

In an embodiment, the method includes utilizing the persistent WebSocket connection for continuous interaction and optimization.

The continuous interaction and optimization may include an ongoing, dynamic process where the server (or serverless architecture) and the client-side script maintain an active exchange of information and instructions to constantly refine and enhance the user experience.

Utilizing the persistent WebSocket connection, the server and client script continuously exchange data. The data exchange may include user behavior analytics, performance metrics, or contextual information. Based on the ongoing data exchange, the server may dynamically adjust the instructions sent to the client. The adjustments may include content updates, UI changes, or performance optimizations. The server (or serverless function) may collaborate with the client script to ensure that the webpage remains optimized for current conditions, such as changing network speeds, user interactions, or device capabilities.

In a server-based architecture, the server continuously monitors various factors like server load, user engagement levels, and content relevance. The server uses the monitored information to send targeted instructions to the client-side script, optimizing the content and performance in real-time.

In a serverless setup, functions may be triggered based on user actions or other metrics. The serverless function may process the data, including user actions, and send back real-time updates or optimizations without the overhead of a persistent server state.

Continuous interaction and optimization may provide for improved efficiency, responsiveness, and personalization of the web application. The method improves web interactions by establishing and leveraging a WebSocket connection, enabling real-time, bidirectional communication between the client and server. Continuous communication provides for immediate responses to user actions, and a more dynamic engagement. The integration of WebSockets with edge computing may reduce latency and improve the efficiency of web content delivery and manipulation.

In traditional systems, the bulk of the Document Object Model (DOM) manipulation and content rendering logic is handled client-side, often leading to slower responses and increased load times. Unlike traditional web systems, the method enables the client-side script to execute instructions received from the server via the WebSocket connection.

Additionally, the method provides for real-time content and DOM manipulations, whereby changes to the webpage's structure, content, and style are executed immediately upon receiving instructions from the WebSocket server. The server-driven updates ensure a more fluid and responsive user experience, with nearly instantaneous changes in response to user actions.

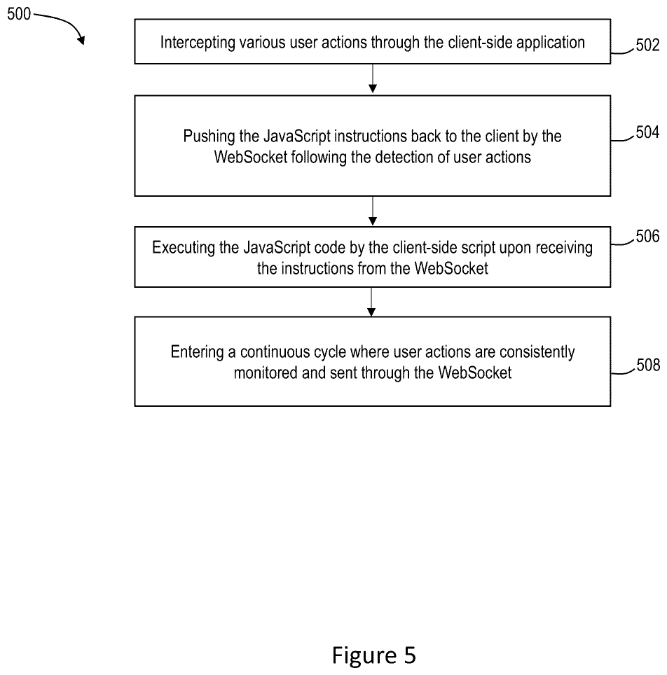

FIG. 5 shows a flow chart of method 500 for dynamic web content delivery and personalization, according to an embodiment.

At 502, the method includes intercepting various user actions through the client-side application. The actions include but are not limited to page load events (on/load), scrolling actions (on/scroll), clicks on various elements (on/click), and navigation or routing changes (on/route/island). These user actions are detected by the client application and sent through the WebSocket for processing.

At 504, the method includes pushing the JavaScript instructions back to the client by the WebSocket following the detection of user actions. The instructions are generated based on the user's actions and the current state of the web application, to provide a dynamic and responsive user experience.

At 506, the method includes executing the JavaScript code by the client-side script upon receiving the instructions from the WebSocket. The execution includes the client-side application processing and implementing any or all instructions sent through the socket. The scope of these instructions may include any one or more of content updates, layout changes, feature activations, or any other modifications dictated by the user's interactions and the application's logic.

At 508, the method includes entering a continuous cycle where user actions are consistently monitored and sent through the WebSocket. The user actions include any one or more of on/load, on/scroll, on/click, on/route/island. The ongoing process ensures that the user's interactions with the web application are continuously captured and responded to in real-time.

In an embodiment, the WebSocket remains actively engaged in pushing appropriate JavaScript instructions to the client side as the user navigates and interacts with the web application. The dynamic delivery provides that the scripts are relevant to the current context and user actions, maintaining an engaging and interactive user experience.

In an embodiment, the client-side application maintains the role of executing the scripts received from the WebSocket. The ongoing execution provides that the web application remains responsive and interactive, adapting to the user's actions and the evolving content of the web page. The client-side script is designed to handle a wide range of instructions, ensuring versatility and adaptability in the web application's behavior.

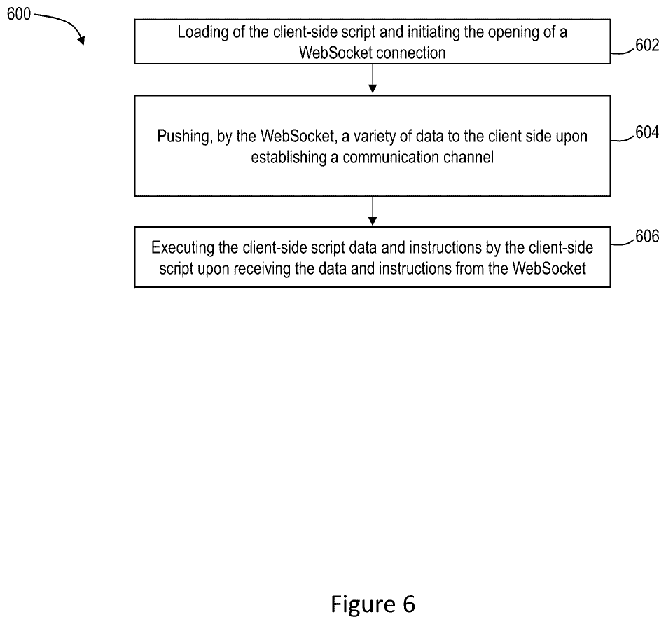

FIG. 6 shows a flow chart of a method 600 for dynamic web content delivery and personalization, according to an embodiment.

At 602, the method includes loading the client-side script. Upon loading, the script initiates the opening of a WebSocket connection. During the connection process, the script may utilize “edge-only” attributes. The attributes include specific configurations or parameters optimized for edge computing environments. The attributes provide that the WebSocket connection and subsequent data handling are optimized for performance and security.

At 604, the method includes, pushing, by the WebSocket, a variety of data to the client side upon establishing a communication channel. The pushed data may include JavaScript code, DOM (Document Object Model) modifications, and hydration data.

In an embodiment, the JavaScript data may provide dynamic scripting capabilities. The DOM modifications may include changes in the webpage's structure or content. The hydration data may provide for updating the client's view and maintaining state consistency.

At 606, the method includes executing the client-side script data and instructions by the client-side script upon receiving the data and instructions from the WebSocket. The execution includes processing and implementing the JavaScript data, applying the DOM modifications, and utilizing the hydration data to provide a seamless, interactive user experience. The script may be designed to handle and execute any content sent through the WebSocket, allowing for real-time updates and responsiveness to user interactions.

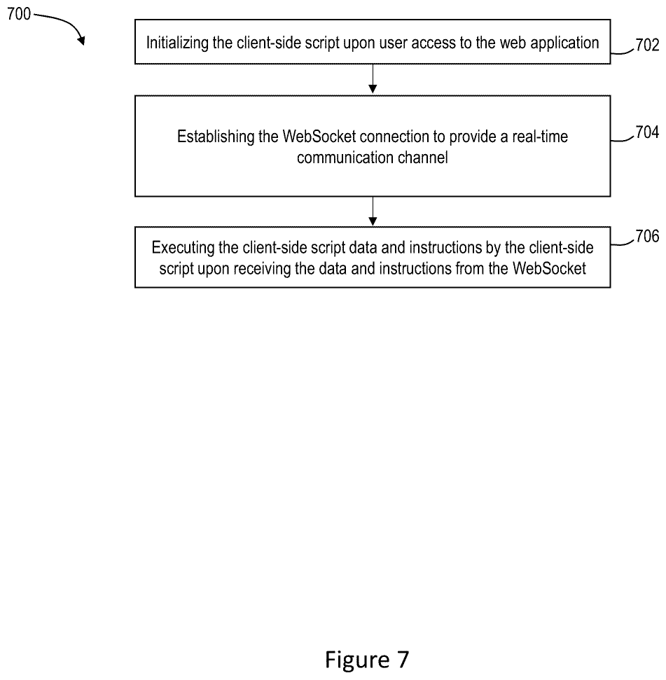

FIG. 7 shows a flow chart of a method 700 for dynamic web content delivery and personalization, according to an embodiment.

At 702, the method includes initializing the client-side script upon user access to the web application. The initialization triggers the opening of a WebSocket connection. The script is configured to use attributes and configurations that are specifically designed for edge computing environments, optimizing the communication for speed and security.

At 704, the method includes establishing the WebSocket connection to provide a real-time communication channel. Through the communication channel, the WebSocket pushes the data to the client side. The data may include but is not limited to, JavaScript code for dynamic functionality, DOM modifications for structural or content changes in the web page, and hydration data to maintain or update the application's state.

At 706, the method includes executing the client-side script data and instructions by the client-side script upon receiving the data and instructions from the WebSocket. The execution includes any one or more of implementing the JavaScript code to introduce new features or functionalities, applying the DOM modifications to alter the web page's layout or content, and using the hydration data to provide that the application remains responsive and up-to-date with the latest changes.

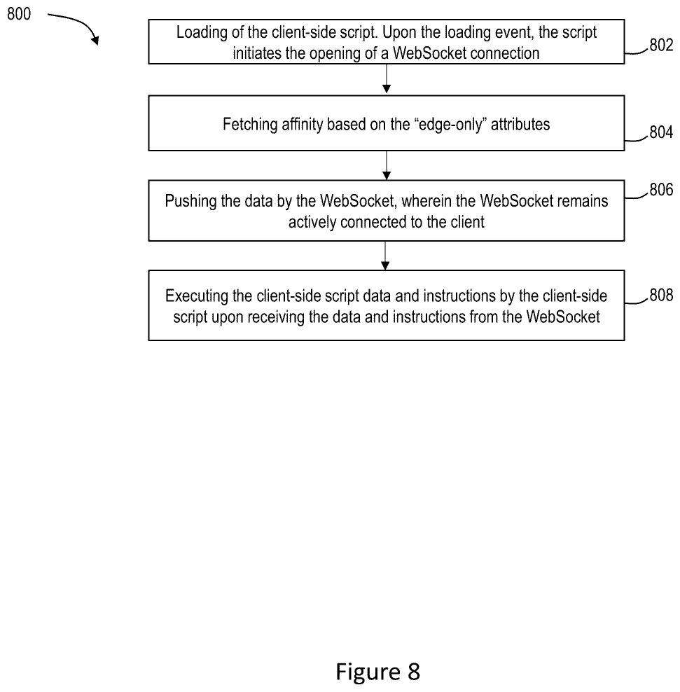

FIG. 8 shows a flow chart of method 800 for dynamic web content delivery and personalization, according to an embodiment.

At 802, the method includes the loading of the client-side script. Upon the loading event, the script initiates the opening of a WebSocket connection. The script may employ “edge-only′ attributes. The attributes include specialized configurations optimized for edge computing environments. The attributes may provide for enhancing the performance and security of the WebSocket connection and data handling.

At 804, the method includes fetching affinity based on the “edge-only” attributes. In an embodiment, the method includes selecting the most suitable network paths or resources based on the attributes defined, ensuring efficient and optimized data transmission. The affinity fetching provides for maintaining a high-performance connection between the client and the edge server, minimizing latency and maximizing data throughput.

At 806, the method includes pushing the data by the WebSocket. The WebSocket remains actively connected to the client. The data includes any one or more of the JavaScript code for enabling dynamic functionalities, DOM (Document Object Model) modifications for making changes to the webpage's structure or content, and hydration data to update and maintain the state of the web application in real-time.

At 808, the method includes executing the client-side script data and instructions by the client-side script upon receiving the data and instructions from the WebSocket. The execution may include any one or more of the applications of JavaScript for new or enhanced functionalities, the implementation of DOM mutations for real-time updates to the webpage, and the use of hydration data to ensure the web application remains responsive and up-to-date.

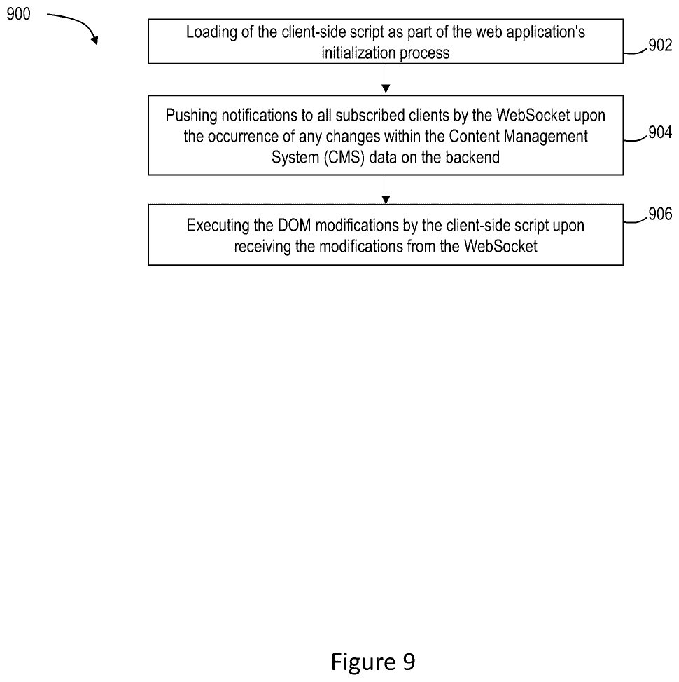

FIG. 9 shows a flow chart of a method 900 for dynamic web content delivery and personalization, according to an embodiment.

At 902, the method includes loading the client-side script as part of the web application's initialization process. Upon this loading event, the client-side script automatically opens a WebSocket connection. This WebSocket is established to provide real-time communication between the client and the server, essential for dynamically updating the user interface based on backend changes.

At 904, the method includes actively pushing notifications to all subscribed clients by the WebSocket upon the occurrence of any changes within the Content Management System (CMS) data on the backend. The notifications comprise of DOM (Document Object Model) modifications that are applied to the clients' web application interfaces. The notifications provide for updating the client experience in real-time, reflecting the latest content changes made in the CMS.

At 906, the method includes executing the DOM modifications by the client-side script upon receiving the modifications from the WebSocket. In an embodiment, the method includes dynamically updating the structure, content, or style of the web pages as per the instructions received. The real-time execution of DOM modifications provides for aligning the user experience with the latest content and layout updates originating from the CMS.

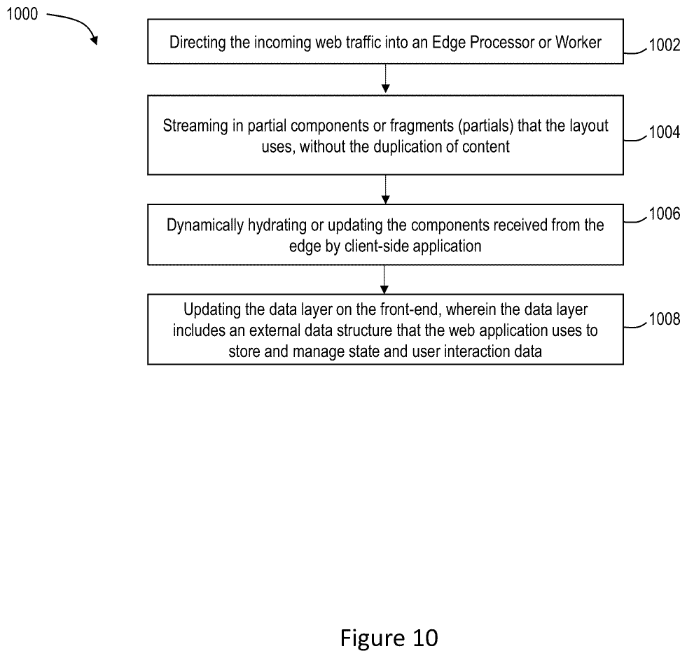

FIG. 10 shows a flow chart of method 1000 for dynamic web content delivery and personalization, according to an embodiment.

At 1002, the method includes directing the incoming web traffic to an Edge Processor or Worker. The Edge Processor provides for handling requests at the network edge, which is crucial for reducing latency and improving the performance of web applications.

In an embodiment, the method includes streaming layouts to the client by the Edge Processor based on the edge attributes of incoming requests. The layouts are configured according to the attributes specified in the request, providing that the content delivered is optimized for the user's current context and device.

At 1004, the method includes streaming in partial components or fragments (partials) that the layout uses, without the duplication of content. The method may include an intelligent caching mechanism at the edge, which prevents redundant data transfer and enhances the efficiency of content delivery.

At 1006, the method includes dynamically hydrating or updating the components received from the edge by client-side application. The hydration process includes rendering the streamed partials into a fully interactive interface. Simultaneously, relevant data may be cached on the front-end to provide quick access and minimize repetitive data fetching.

In an embodiment, the method includes managing a component registry on the front-end. The registry keeps track of all the components that have been loaded and their states, aiding in efficient updates and rendering processes. The registry provides for organizing the web application and making it responsive to dynamic changes.

At 1008, the method includes updating the data layer on the front-end. The data layer includes an external data structure that the web application uses to store and manage state and user interaction data. The layer is continuously updated to ensure that the user interface accurately reflects the latest interactions and data states.

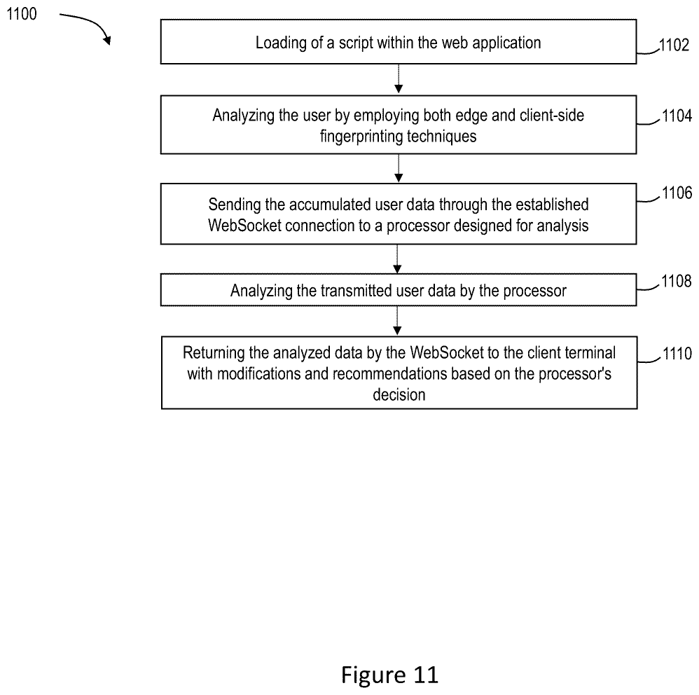

FIG. 11 shows a flow chart of a method 1100 for dynamic web content delivery and personalization, according to an embodiment.

At 1102, the method includes loading a script within the web application.

At 1104, the method includes analyzing the user by employing both edge and client-side fingerprinting techniques. The comprehensive analysis provides detailed insights about the user, leveraging the capabilities of edge computing in conjunction with client-side data collection.

At 1106, the method includes sending the accumulated user data through the established WebSocket connection to a processor designed for analysis. The transmission provides that the user data is securely and efficiently communicated to the backend for further processing.

At 1108, the method includes analyzing the transmitted user data by the processor. The analysis includes processing a plurality of dimensions of user information, including any one or more of the devices being used, the user's geographic location, the user's affinity with certain products or services, projected budget, and any predefined filters or attributes that may be relevant to their browsing experience.

At 1110, the method includes returning the analyzed data by the WebSocket to the client device with modifications and recommendations based on the processor's decision. The modifications are configured to the user's profile and preferences, ensuring that the content and experience presented to them are highly personalized and relevant.

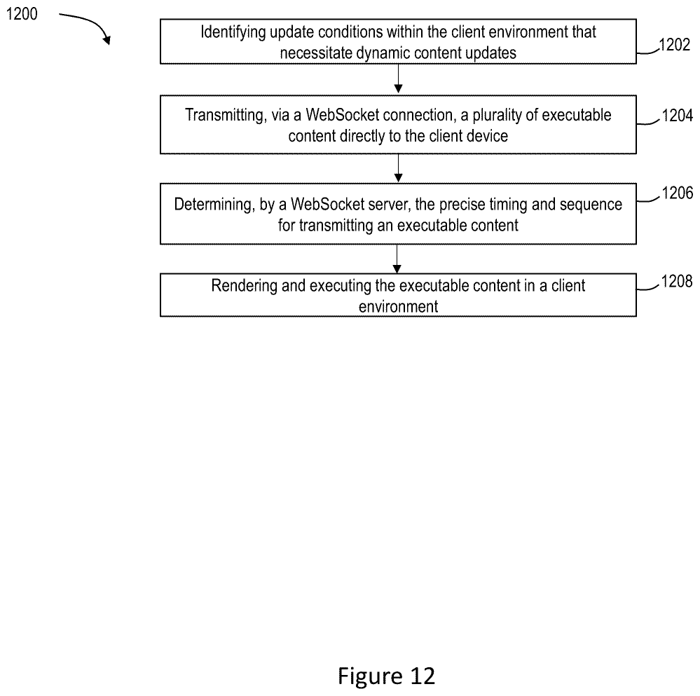

FIG. 12 shows a flow chart of method 1200 for dynamic web content delivery and personalization, according to an embodiment.

At 1202, the method includes identifying update conditions within the client environment that necessitate dynamic content updates.

The update conditions may include user actions (clicks and scrolls), triggers such as reaching a certain point within the web application, or changes in the user's interaction pattern. The identification process provides for determining when and what type of executable content needs to be transmitted to meet the user's current needs.

At 1204, the method includes transmitting, via the WebSocket connection, a plurality of executable content directly to the client device.

The executable content may include but is not limited to, JavaScript code for functionality enhancement, CSS stylesheets for visual updates, and HTML elements for structural modifications. The use of WebSocket for this transmission provides for eliminates the need for additional HTTP requests thereby reducing latency.

At 1206, the method includes determining, by the WebSocket server, the precise timing and sequence for transmitting the executable content.

By conducting a real-time analysis of the user's behavior, the current state of the webpage, and various predefined performance metrics, the WebSocket server intelligently decides how to prioritize and schedule content updates. Therefore, the executable content is not only relevant but also delivered at the optimal moment for execution.

The WebSocket server may perform analysis through algorithms that process incoming data streams from the client device, identifying patterns, user interactions, and the immediate needs of the application. The decision-making framework dynamically adjusts the delivery of executable content, optimizing for the most effective user engagement and application performance.

At 1208, the method includes rendering and executing the executable content in a client environment.

The transmitted executable content is efficiently rendered and executed within the client environment. The method provides instantaneous updates to the web application's content and DOM without necessitating any additional HTTP requests. Such a feature facilitates a highly responsive and interactive user experience, with content and layout dynamically adapting to user interactions in real-time.

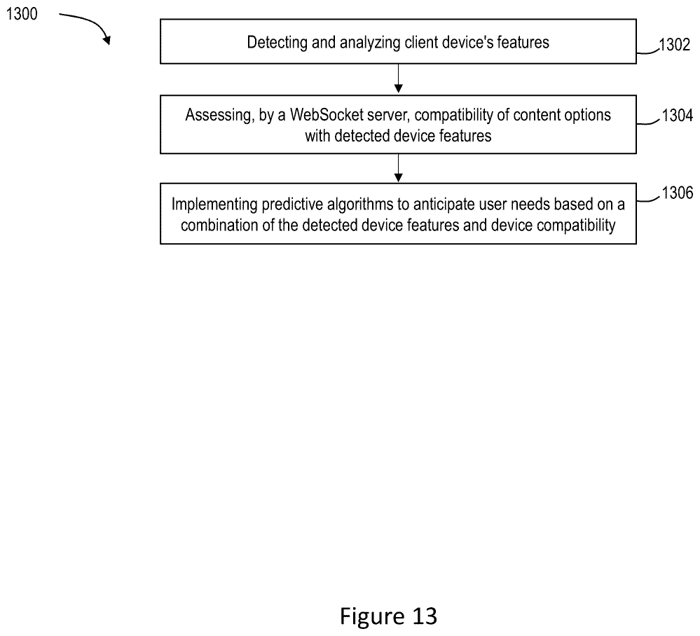

FIG. 13 shows a flow chart of method 1300 for dynamic web content delivery and personalization, according to an embodiment.

At 1302, the method includes detecting and analyzing the client device's features.

The client device's features include any one or more of the device models, operating system, screen resolution, internet service provider, network conditions, and device capabilities. The method provides for detecting the environment in which the web application is operating, ensuring that subsequent content delivery is tailored to the specific constraints and advantages of the user's device and network.

At 1304, the method includes assessing, by the WebSocket server, the compatibility of content options with detected device features. The WebSocket server may pre-select or filter content, ensuring that only the most suitable and compatible content is considered for delivery to the client device. The compatibility check provides for avoiding the transmission of content that the device may not efficiently render or that may lead to suboptimal user experiences due to device limitations.

At 1306, the method includes implementing predictive algorithms to anticipate user needs based on a combination of the detected device features and device compatibility.

The method provides for preloading or prioritizing the delivery of the content that is most likely to enhance the user experience on the specific device and network. The prediction may be based on the device model (e.g., iPhone 15 Pro), service provider (e.g., Verizon), and compatibility features (e.g., Apple CarPlay). By predicting user needs and adjusting content delivery accordingly, the method provides that users receive content that is not only relevant and engaging but also optimized for their current usage context.

The embodiments described herein represent a range of systems, methods, and devices for enhancing web content delivery and user interaction. It should be noted that these embodiments are not mutually exclusive and may intersect or integrate in various implementations. Processes or features from one embodiment may be adaptable or combinable with those from another, providing flexibility and customization in the application of these methods.

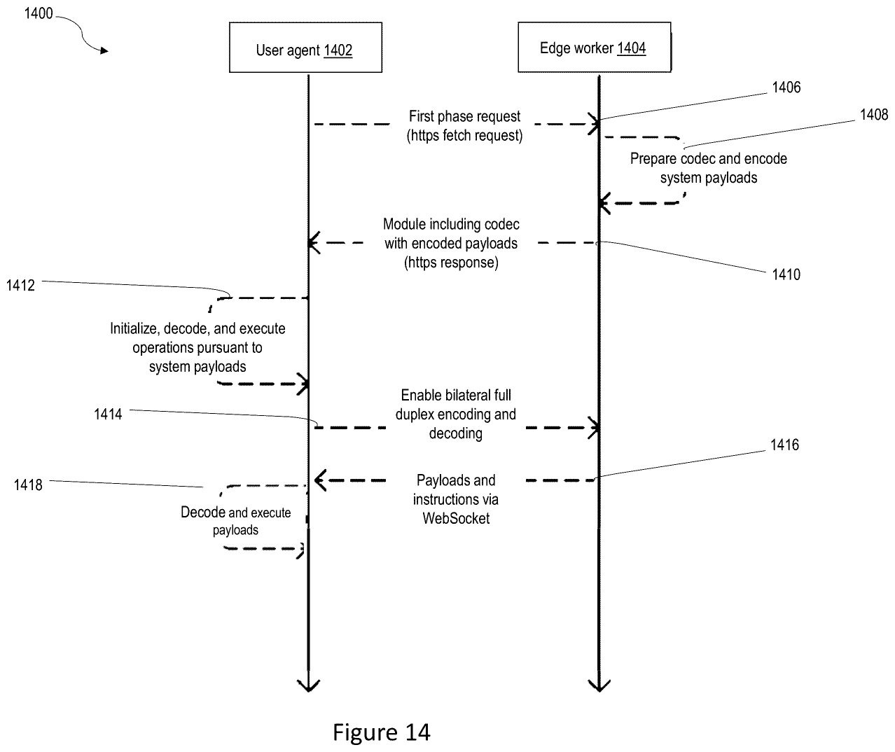

Referring now to FIG. 14, shown therein is a workflow 1400 for dynamic web content delivery and personalization as performed by or with a user agent 1402 and an edge worker 1404, according to an embodiment. The workflow 1400 relates to WebAssembly (WASM) encoding and decoding.

The user agent 1402 is configured to communicate with the edge worker 1404 to retrieve a codec using WASM and system payloads (including at least first phase system payloads) and to initialize the WASM code. The user agent 1402 is further configured to send analytics and telemetry data back to the edge worker 1404.

The WASM code is configured to encode, decode, and execute the system payloads in the user agent 1402.

The edge worker 1404 is configured to host the WASM code and the system payloads for retrieval by the user agent 1402 and to communicate with the user agent 1402. The edge worker 1404 is further configured to retrieve and process analytics and telemetry data from the user agent 1402.

At 1406 in the workflow 1400, the user agent 1402 sends a first phase request (e.g., an https fetch request) to the edge worker 1404.

At 1408 in the workflow 1400, the edge worker 1404 prepares the codec and further encodes the first phase system payloads responsive to the first phase request.

At 1410 in the workflow 1400, the edge worker 1404 sends a module including the codec with the encoded first phase system payloads (e.g., via an https response).

At 1412 in the workflow 1400, the user agent 1402 initializes, decodes, and executes operations pursuant to the first phase system payloads.

At 1414 in the workflow 1400, the user agent 1402 enables bilateral full duplex encoding and decoding.

At 1416 in the workflow 1400, the edge worker 1404 sends the first phase system payloads and instructions, via WebSocket, to the user agent 1402.

At 1418 in the workflow 1400, the user agent 1402 decodes and executes the first phase system payloads and instructions.

The codec module may be compiled to WebAssembly module (WASM). The compiled codec delivered via WASM operates in a synchronous manner to achieve greater security and speed of execution (e.g., via the first phase request). Conventionally, WASM code is compiled from programming languages such as C, C++ or Rust via WASM compilers and interfaced with Javascript code.

Advantageously, the WASM code according to the present disclosure is built without common Javascript “glue code” libraries and the imported functions are supplied separately when the WASM code is initialized in a synchronous manner.

The payloads are encrypted and decrypted in the workflow 1400 in the first phase, for example using AES 128-bit encryption and decryption. In an embodiment, the AES library is written in C and compiled to the WASM code. The WASM code operates on phased payloads and comes together with the payload at the user agent 1402. The WASM code decodes the payload and executes the payload.

In an embodiment, the payloads go through the WebSocket and operate in the user agent 1402 to speed up and optimize the user experience. The user agent 1402 employs the WASM code to decode the payloads and execute the payloads in real time.

The workflow 1400 may be applied to or with any WASM code, i.e., the foregoing workflow 1400 is not limited to WASM for encoding and decoding payloads. The workflow 1400 may be suitable for any WASM code to be delivered quickly and synchronously. Examples include but are not limited to:
a) WASM code that manages the <script> tag on the website to optimize the loading process;
b) WASM code that processes and optimizes initial CSS code;
c) WASM code that processes and optimizes initial images.

The payloads may include payloads other than Javascript code, e.g., other code that operates in the user agent 1402. Examples include but are not limited to:
a) WASM code that runs a Web Worker or Service Worker to achieve parallelized data processing;
b) WASM code that runs WebGL or WeGPU code to customize event rendering;
c) WASM code that improves networking performance by employing Application Cache.

While the above description provides examples of one or more apparatus, methods, or systems, it will be appreciated that other apparatus, methods, or systems may be within the scope of the claims as interpreted by one of skill in the art.

1. A system for dynamic web content delivery, the system comprising:
a client device configured to execute a client-side script, the client-side script configured for initiation of one or more simultaneous two-way communication connections, detection and transmission of user actions, and execution of instructions received, for dynamic content updates, from a server for the one or more simultaneous two-way communication connections,
the server configured to establish and maintain the one or more simultaneous two-way communication connections with the client device, the server configured for real-time data exchange with the client device to receive user actions, determine an executable response based on a predefined logic, and delivery of the instructions for real-time content manipulation, wherein the instructions include the executable response; and
a database configured to manage user-specific data and deliver the user-specific data to the server to support execution of the predefined logic and content customization based on user interactions.

2. The system of claim 1, wherein the one or more simultaneous two-way communication connections are one or more WebSocket connections, and wherein the server is a WebSocket server.

3. The system of claim 2, wherein the WebSocket includes a message handler configured to process incoming and outgoing messages related to user interactions and server responses.

4. The system of claim 3, wherein the WebSocket includes a script decision maker to determine the loading and execution of scripts based on user interaction and context.

5. The system of claim 2, wherein the WebSocket is any one or more of a dedicated server, a cloud-based server instance, and an edge computing worker instance, configured to interpret the user actions sent from the client device and send the instructions for real-time content manipulation.

6. The system of claim 5, wherein the WebSocket server is configured to maintain the one or more WebSocket connections with multiple client devices simultaneously and determine responses based on a combination of user actions, context, and predefined logic and algorithms.

7. The system of claim 5, wherein the WebSocket server is configured to perform real-time interpretation of the user actions received from the client device, the real-time interpretation including categorizing actions into types such as navigation, interaction, or viewing actions, and dynamically generating responses tailored to a specific context for the user action.

8. The system of claim 7, wherein the WebSocket server is configured to send commands to the client device for any one or more of pausing, resuming, or altering an execution flow of the plurality of client-side scripts.

9. The system of claim 2, wherein the client-side script includes a lightweight proxy object configured for intelligent chunking, intercepting function calls, and dynamically loading required code modules and dependencies via the one or more WebSocket connections.

10. The system of claim 2, wherein the WebSocket server is configured to manage a prioritized queue for script execution and resource loading, wherein the client-side script is adapted to determine script activation based on a combination of user interactions, application milestones, and predefined conditions.

11. The system of claim 2, wherein the WebSocket server is configured to interpret real-time changes initiated by client-side scripts, categorize user actions into action types, the action types including DOM changes, script insertions, and function utilizations within the web application, and dynamically generate responses tailored to the action types.

12. A method for real-time web content delivery and interaction, comprising:
installing a client-side script on the front end of a web application, the client-side script configured for initiating one or more simultaneous two-way communication connections and processing user interactions;
establishing the one or more simultaneous two-way communication connections for continuous data exchange between the client-side script and a remote communication handler for continuous data exchange;
detecting and monitoring user actions and HTML manipulations in real-time via the client-side script within a user browser environment for dynamic interaction with the web application;
interpreting a plurality of detected user actions at the remote communication handler, and determining an executable instruction in response to the user actions;
transmitting the executable instruction from the remote communication handler to the client-side script via the one or more simultaneous two-way communication connections; and
executing the received instructions on a client-side user interface for real-time content delivery.

13. The method of claim 12, wherein the one or more simultaneous two-way communication connections are one or more WebSocket connections.

14. The method of claim 12, wherein the remote communication handler includes any one of a server or a serverless function.

15. The method of claim 12, wherein the client-side script includes functionality for pausing and resuming execution based on control commands received from the remote communication handler, allowing for dynamic adjustment of script execution of any script loaded into the web application.

16. The method of claim 12, further comprising categorizing the user actions into navigation actions, interaction actions, and viewing actions, wherein the remote communication handler tailors the instructions based on the category of the detected user action to enhance the relevance and efficiency of the web application's response.

17. The method of claim 12, wherein the real-time content and DOM manipulations include dynamic updates to the webpage's structure, content, and style without requiring a page reload, wherein the dynamic updates are executed immediately upon receiving instructions from the remote communication handler.

18. The method of claim 12, further comprising the execution of the client-side script within the same user session, enabling a highly responsive and dynamic user interaction model without the need for page reloads or manual refreshes.

19. The method of claim 13, wherein the one or more WebSocket connections include pushing hydration data to the client, maintaining the state and functionality of the webpage as the user interacts with it, ensuring a seamless and continuous user experience.

20. The method of claim 13, further comprising rendering and executing transmitted executable content within the client environment, wherein the executable content is selected and transmitted based on identified update conditions within the client environment, including user actions and interaction patterns, and determined by a WebSocket server in terms of timing and sequence.

21. The method of claim 20 further comprising detecting and analyzing the client device's features including device model, operating system, screen resolution, internet service provider, network conditions, and device capabilities, and assessing, by the WebSocket server, content compatibility with detected features to tailor content delivery.

22. A device for dynamic web content delivery via one or more simultaneous two-way communication connections, the device comprising:
a message handler configured to process incoming and outgoing messages through the one or more simultaneous two-way communication connections, including interpreting user actions, requests for data, and commands from a server;
a script decision maker configured to determine scripts for load and execution based on user interaction, page context, and client-side script, and dynamically evaluate an application's context and user interactions to determine the scripts to activate within the web application;
a state manager configured to manage an application state in real-time by tracking the user interaction and the client-side script;
a real-time response unit configured to instantly process user actions received from the message handler and generate appropriate responses, including any one or more of dynamically updating page content, altering layouts, or changing styles, to ensure the web application remains responsive to user needs and server logic; and
a queue management module configured to prioritize and sequence the execution of scripts and user actions within a prioritized queue.

23. The device of claim 22, wherein the one or more simultaneous two-way communication connections are one or more WebSocket connections.

24. A method for dynamic web content delivery and personalization via encoding and decoding, the method comprising:
providing a user agent configured to communicate with an edge worker to retrieve a codec and system payloads and to initialize the codec, the system payloads including first phase system payloads;
wherein the codec is configured to encode, decode, and execute the system payloads in the user agent; and
providing the edge worker configured to host the codec and the system payloads for retrieval by the user agent and to communicate with the user agent.

25. The method of claim 24 further comprising:
the user agent sending a first phase request to the edge worker;
the edge worker preparing the codec and further encoding the first phase system payloads responsive to the first phase request;
the edge worker sending a module including the codec with the encoded first phase system payloads;
the user agent initializing, decoding, and executing operations pursuant to the first phase system payloads;
the user agent enabling bilateral full duplex encoding and decoding;
the edge worker sending the first phase system payloads and instructions via WebSocket; and
the user agent decoding and executing the first phase system payloads.

26. The method of claim 24, wherein the codec is delivered using WASM, wherein the WASM code operates in a synchronous manner to achieve greater speed in loading websites and increased security, and wherein imported functions are supplied separately when the WASM code is initialized in the synchronous manner.

27. The method of claim 26, wherein the WASM code is transformed into a text format suitable for the fetch request including the system payloads, wherein the WASM code is delivered in the fetch request that includes the system payloads, and wherein the WASM code is extracted from the fetch request and initialized in the user agent.

28. The method of claim 24, wherein the system payloads are executed immediately upon decoding.

29. The method of claim 24, wherein the system payloads are encrypted and decrypted using AES 128-bit encryption and decryption.

30. The method of claim 26, wherein the system payloads go through the WebSocket and operate in the user agent to speed up and optimize the user experience.
